(19) United States
(12) Patent Application Publication
(10) Pub. No.: US 2013/0083540 A1
(43) Pub. Date: Apr. 4, 2013

(54) POLYMER FILM AND ITS APPLICATION IN A LIGHTING ASSEMBLY

(71) Applicant: TAIMIDE TECHNOLOGY INCORPORATION, Hsinchu County (TW)

(72) Inventors: Chi-Huan LO, Hsinchu Hsien (TW); Ching-Wen YU, Hsinchu Hsien (TW); Sheng-Yu HUANG, Hsinchu Hsien (TW)

(73) Assignee: TAIMIDE TECHNOLOGY INCORPORATION, Hsinchu County (TW)

(21) Appl. No.: 13/630,824

(22) Filed: Sep. 28, 2012

(30) Foreign Application Priority Data
Sep. 30, 2011 (TW) 100135572

(51) Int. Cl. F21V 7/22; C09J 7/02

(52) U.S. Cl. 362/307; 428/343; 428/355 EP; 428/355 AC; 428/355 N; 428/355 R; 428/323; 428/335

(57) ABSTRACT

Present embodiments provide for a polymer film with a reflective ratio equal to or above about 80%, comprising a white polyimide layer and a white adhesive layer disposed on a surface of the white polyimide layer The white adhesive layer including an adhesive agent and a white filler distributed in the adhesive agent. Present embodiments also provide for a lighting assembly that comprises a substrate, a lighting component disposed on the substrate, and a reflective surface formed by the polymer film.

### CROSS-REFERENCE TO RELATED APPLICATION

This application claims priority of Taiwan patent application No. 100135572 filed on Sep. 30, 2011.

### TECHNICAL FIELD

The present invention relates to a polymer film, especially a polymer film used to provide a reflective surface that may be used in lighting assemblies.

### BACKGROUND

Polyimide films are lightweight, flexible, and exhibit excellent mechanical properties as well as good resistance to heat and chemicals. Polyimide films are widely used in the electronics industry, such as in the fabrication of light-emitting diode (LED) assemblies, liquid crystal display (LCD) devices and the like. Polyimide films can also be used as a polymer film in heat resistant tapes and flexible print circuit boards (FPC), passivation coating in integrated circuits (IC), alignment film in the structure of a LCD panel, and insulation material such as enameled wire, etc.

In energy-saving applications, LEDs are increasingly used for lighting assemblies. Advantages of the LED include good light conversion rate, long service time, and reduced power consumption. One approach for efficiently increasing the brightness consists of increasing the reflection from a back plate placed behind the LED.

Current LED assemblies typically use a dual-layer polyimide film as a covering layer. This dual-layer polyimide is formed by coating a white resin on a polyimide film. The polyimide film usually exhibits slightly yellow to brown color with a thickness of 12.5 μm or 25 μm. The white resin is generally made of an epoxy resin, acrylic resin or other polymers, and has a thickness between about 10 μm and 20 μm. In order to adhere this film to the LED, an adhesive layer is applied on a side of the dual-layer polyimide film opposite to the white resin layer. The adhesive layer can generally have a thickness between about 10 μm and 50 μm. The covering layer thereby formed has a total thickness between about 35 μm and 75 μm (not including the to release layer), which may be too thick to provide effective bending ability. Although this covering film can exhibit white color and can be prepared at low cost, the resin layer usually has poor resistance to heat, and may easily yellow and alter under high temperature. This may affect the ability of the film structure to reflect light and also have an impact on the processing steps. The formation of the resin layer may also complicate the fabrication process of the dual-layer film structure, and introduce potential surface contamination.

In order to solve the aforementioned issues associated with the resin layer, some approaches propose forming a white polyimide film as the reflective layer, and a transparent adhesive layer is used to bond the white polyimide film. However, the white polyimide film generally has some degree of light transmittance, so a certain film thickness is required to yield sufficient shielding. Typically, the thickness of the white polyimide film has to be above 25 μm to provide sufficient shielding (generally between 25 μm and 50 μm), which increase the thickness of the polymer film comprised of the white polyimide film and the adhesive layer (usually between 35 μm and 100 μm not including the release layer). The increased thickness of the white polyimide film requires in a higher manufacture cost, and may be incompatible with applications requiring thinner dimensions.

Therefore, there is a need for a structure of a white polymer film that can be used as a reflective surface and address the foregoing issues.

### SUMMARY

Embodiments of the present application describe a polymer film having a reflective ratio equal to or above about 80% which comprises a white polyimide layer and a white adhesive layer disposed on a surface of the white polyimide layer. The white adhesive layer may include an adhesive agent and a white filler distributed in the adhesive agent.

Embodiments of the present application also describe a lighting assembly comprising a substrate, a lighting component disposed on the substrate, and a reflective surface formed by the polymer film.

The polymer films described herein may have the ability to prevent yellowing and alterations at high temperature. Additionally, the structure of the polymer films can have a reduced thickness compared to conventional film structures, and can provide a high reflective ratio.

### BRIEF DESCRIPTION OF THE DRAWINGS

FIG. 1 is a schematic view illustrating an embodiment of a polymer film; and

FIGS. 2A-2D are schematic views illustrating one embodiment of the process for manufacturing a lighting assembly.

### DETAILED DESCRIPTION

For a more complete understanding of the present disclosure and its advantages, reference is now made to the following descriptions taken in conjunction with the accompanying drawings, in which like reference numbers indicate like features. Persons having ordinary skill in the art will understand other varieties for implementing example embodiments, including those described herein. As used in the disclosures and the appended claims, the terms “example embodiment,” “exemplary embodiment,” and “present embodiment” do not necessarily refer to a single embodiment, although it may, and various example embodiments may be readily combined and interchanged, without departing from the scope or spirit of the present invention. Furthermore, the terminology as used herein is for the purpose of describing example embodiments only and is not intended to be a limitation of the invention.

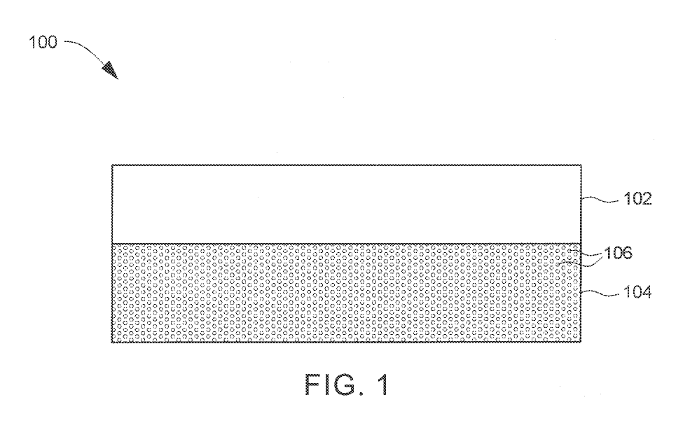

FIG. 1 is a schematic view illustrating a structure embodiment of a polymer film 100. The polymer film 100 may comprise a white polyimide layer 102 and a white adhesive layer 104. The white adhesive layer 104 may comprise an adhesive agent, and a white coloration filler 106 distributed in the adhesive agent in a uniform manner. During application, the polymer film 100 can be adhered to a substrate via the white adhesive layer 104.

Examples of the adhesive agent, which can be used alone or in combination can include, but are not limited to, epoxy resins, acrylics, silicones, phenolics, polyurethanes, rubbers, and the like.

In an example embodiment, the adhesive agent can be an epoxy resin. The epoxy resin can include, without limitation, bisphenol A type epoxy resin, novolac epoxy resins (such as phenol novolac epoxy resin, o-cresol novolac epoxy resin, bisphenol A type novolac epoxy resin and the like), aliphatic epoxy resins (such as linear aliphatic epoxy resin or cycloaliphatic epoxy resin), polybutadiene epoxy resins and the like. In another example embodiment, the adhesive agent may be bisphenol A type epoxy resin.

The white coloration filler 106 can include, but is not limited to, TiO₂, ZrO₂, CaO, ZnO₂, Al₂O₃, ZnS₂, CaCO₃, PbCO₃, Pb(OH)₂, CaSO₄, BaSO₄, SiO₂, BN, AlN, basic zinc molybdate, basic calcium zinc molybdate, lead white, molybdenum white, lithopone (a mixture of BaSO₄ and ZnS₂), clay and the like. The above fillers can be used alone or in combination. In some embodiments, the used white coloration filler 106 can be clay. [QUESTION: IS THIS A PREFERRED EMBODIMENT? IF SO, WHY?]

It is to be appreciated that the ratio of the white coloration filler to the adhesive agent can be adjusted according to the desired properties of the polymer film. In one embodiment, the white adhesive layer 104 composed of the white coloration filler 106 and the adhesive agent may have a transparency of about 20% or lower. This white adhesive agent can be used to adhere a polymer film with a lighting assembly (such as LED assembly), and can increase the reflective ratio and shielding effect of the polymer film, such that the polymer film can be used as an effective reflecting surface.

The white coloration filler 106 can be between about 5 wt % and 80 wt % of a total weight of the white adhesive layer. In particular, the white coloration filler 106 can be about 5 wt %, 10 wt %, 15 wt %, 20 wt %, 30 wt %, 40 wt %, 50 wt %, 60 wt %, 65 wt %, 70 wt %, 75 wt %, 80 wt %, or an intermediate value between any of these values. In one embodiment, the white coloration filler can be between about 10 wt % and about 70 wt %, more specifically between about 25 wt % and about 70 wt %.

In some embodiments, the white coloration filler 106 may be in powder form. The particle size of the white coloration filler 106 may have an impact on certain properties of the polymer film. When the average particle size is lower than 0.1 μm, the white coloration filler 106 may have poorer dispersion, and adding a greater quantity of the white coloration filler 106 may still be ineffective to obtain the desired coloration for the overall polymer film 100. In contrast, when the average particle size of the white coloration filler is larger than 5 μm, the polymer film 100 may exhibit an excessive surface roughness that may be incompatible with a desired surface appearance. Accordingly, the white coloration filler 106 used can have an average particle diameter between about 0.1 μm and about 5 μm, such as 0.1 μm, 0.2 μm, 0.3 μm, 0.4 μm, 0.5 μm, 0.6 μm, 0.7 μm, 0.8 μm, 0.9 μm, 1 μm, 1.5 μm, 2 μm, 2.5 μm, 3 μm, 3.5 μm, 4 μm, 4.5 μm, 5 μm, or an intermediate value between any of these values.

The white polyimide layer 102 can be integrally formed as a single polyimide layer exhibiting white color. In some embodiments, a plurality of layers can also be stacked to form the white polyimide layer 102.

The white polyimide layer 102 can be formed by polymerization reaction from multiple monomers, such as diamine and dianhydride components. A suitable coloration filler (such as a pigment) can be mixed with the polyimide so that the white polyimide layer 102 can exhibit white color.

In some embodiments, the white polyimide layer 102 can incorporate a low chroma polyimide having a b* value lower than about 10, and a white coloration filler distributed in the low chroma polyimide. The b-value is an index defined in the conventional “L*a*b*color space” for characterizing a color dimension between yellow and blue. In some embodiments, 2,2′-bis(trifluoromethyl)benzidine (TMFB) and 3,3′,4,4′-biphenyltetracarboxylic dianhydride (BPDA) can be used to form a low chroma polyimide having a b* value less than about 10, and the white coloration filler can be to homogenously mixed in the low chroma polyimide to form the white polyimide layer 102. In some embodiments, 2,2-bis[4-(3,4-dicarboxyphenoxy)phenyl]propane dianhydride (BPADA) may be reacted with BPDA and TMFB to form a low chroma polyimide, and the white coloration filler can be homogenously mixed in the low chroma polyimide to form the white polyimide layer 102.

Any of the aforementioned white coloration fillers forming the white adhesive layer 104 may be used as the white coloration filler for the white polyimide layer 102. The two white fillers used respectively for the white polyimide layer 102 and the white adhesive layer 104 can be identical or different from each other. In some embodiments, the white coloration filler used for the white polyimide layer 102 can be selected from one or more of the group consisting of TiO₂, Al₂O₃, CaCO₃, CaSO₄, SiO₂, BN, AlN, and clay. The white polyimide layer containing the white filler may have a transparency equal to or smaller than about 20%.

Compared with conventional film structures, a total thickness (not including a release layer) of the polymer film 100 can be significantly reduced to between about 23 μm and about 68 μm, which is particularly suitable for applications requiring a thin dimension. The white adhesive layer 104 can have a thickness similar to the conventional adhesive layer, e.g., about 50 μm. In some embodiments, the thickness of the white adhesive layer 104 can be between about 10 μm and about 50 μm. The white polyimide layer 102 can be thinner than the white adhesive layer 104, such as less than 30 μm. In particular, the thickness of the white polyimide layer 102 may be less than 18 μm, for example about 12.5 μm.

The polymer film 100 has a reflective ratio of about 80% or even above, e.g., equal to or above about 85%.

In contrast to conventional films, the light transmittance of the polymer film 100 can also be reduced to about 25% or less, e.g., equal to 20% or even lower, which can increase the shielding capability of the film. In one embodiment, the light transmittance ratio can be lower than 15%, in particular below 10%, such as about 9%, or between about 5% and about 6%.

Examples of fabrication of the polymer film and its application in lighting assemblies are described hereafter.

### Preparation of the Polyimide Layer

### Example 1.1

At an ambient temperature, nitrogen gas is fed into a 500 ml three-necked flask used as a polymerization vessel, all the reactions being conducted in a nitrogen environment. About 160 g of dimethylacetamide (DMAC) used as solvent is added into the flask. Then, about 18.774 g (corresponding to about 0.060 mole) of TMFB is incorporated into the DMAC solvent. After the TMFB is completely dissolved in the DMAC solvent, about 13.354 g (corresponding to about 0.045 mole) of BPDA and about 7.873 g (corresponding to about 0.015 mole) of BPADA are added into the liquid solution. About 8.411 g of a TiO₂ slurry with about 50% of solid content can also be incorporated into this mixture, which is continuously agitated for 4 hours to form a polyamic acid (PAA) solution.

The PAA solution can be mixed with a dehydrant acetic anhydride and a catalyst picoline to obtain a precursor solution. Then, a layer of the precursor solution is coated onto a glass plate support by using a coating blade. The coated layer having a thickness of about 0.5 mil (i.e. 12.5 μm) can be baked in a furnace in a stepwise manner at about 100° C. for 30 minutes, then about 200° C. for 30 minutes, and subsequently about 300° C. for 30 minutes. A white polyimide layer then can be peeled from the glass plate support.

### Example 1.2

A white polyimide layer prepared like Example 1.1, wherein the PAA solution is mixed with about 25.833 g of a TiO₂ slurry with about 50% of solid content.

### Example 1.3

A white polyimide layer prepared like Example 1.1, wherein the PAA solution is mixed with about 51.66 g of a TiO₂ slurry with about 50% of solid content.

### Example 1.4

A polyimide film prepared like Example 1.1, wherein no TiO₂ slurry is mixed with the PAA solution. Accordingly, the formed polyimide layer does not exhibit white color.

### Example 1.5

A white polyimide layer prepared like Example 1.1, wherein the PAA solution is mixed with about 25.833 g of a TiO₂ slurry with about 50% of solid content, and the coated layer has a thickness of about 1 mil (i.e., about 25 μm).

### Preparation of the Polymer Film

### Example 2.1

About 0.385 g of a curing agent (e.g., sold by Arakawa Chemical Industries, Ltd under the designation “HBAD028-2”) and about 1.48 g of a TiO₂ slurry with about 50% of solid content can be added with about 50 g of bisphenol A type epoxy resin (e.g., sold by Arakawa Chemical Industries, Ltd. under the designation “HBAD028-1”), this mixture being agitated for 2 hours at an ambient temperature to form a white adhesive agent.

The white adhesive agent can be coated onto the white polyimide layer formed according to Example 1.2 by using a coating blade. The white polyimide layer with the white adhesive agent thereon then can be baked in a furnace in a stepwise manner at about 80° C. for 30 minutes, and subsequently about 170° C. for 30 minutes. The obtained polymer film structure has a total thickness of about 2 mil (i.e., about 50 μm).

### Example 2.2

A polymer film prepared like Example 2.1, wherein about 4.15 g of a TiO₂ slurry with about 50% of solid content is mixed with the epoxy resin in the fabrication of the white adhesive agent.

### Example 2.3

A polymer film prepared like Example 2.1, wherein about 7.11 g of a TiO₂ slurry with about 50% of solid content is mixed with the epoxy resin in the fabrication of the white adhesive agent.

### Example 2.4

A polymer film prepared like Example 2.1, wherein about 11.07 g of a TiO₂ slurry with about 50% of solid content is mixed with the epoxy resin in the fabrication of the white adhesive agent.

### Example 2.5

A polymer film prepared like Example 2.1, wherein about 16.60 g of a TiO₂ slurry with about 50% of solid content is mixed with the epoxy resin in the fabrication of the white adhesive agent.

### Comparative Example 1

A polymer film prepared like Example 2.1, wherein no TiO₂ slurry is mixed with the epoxy resin in the fabrication of the white adhesive agent.

### Comparative Example 2

A polymer film prepared like Example 2.1, wherein no TiO₂ slurry is mixed with the epoxy resin, and the white polyimide layer fabricated according to Example 1.5 is used instead of that fabricated according to Example 1.2.

Experiment 1

The white polyimide layers fabricated according to Examples 1.1-1.5 can be tested to determine a reflective ratio, light transmittance ratio, and mechanical elongation rate. Examples of the test results are shown in Table 1 below.

TABLE 1
Test results of white polyimide film

| | | Film | Reflective | Light | Elongation |
|---|---|---|---|---|---|
| | TiO₂ | thickness | ratio | transmittance | rate |
| | (wt %) | (μm) | (%) | ratio (%) | (%) |
| Example | 10 | 12.2 | 81.2 | 50.1 | 38 |
| 1.1 | | | | | |
| Example | 25 | 12.4 | 83.3 | 33.2 | 30 |
| 1.2 | | | | | |
| Example | 40 | 12.3 | 86.1 | 15.2 | 8 |
| 1.3 | | | | | |
| Example | 0 | 12 | — | 90.1 | 45 |
| 1.4 | | | | | |
| Example | 25 | 25 | 85.1 | 24.1 | 40 |
| 1.5 | | | | | |

The light transmittance ratio can be measured with a testing apparatus available from Nippon Denshoku under the designation “PG-1M”. The mechanical elongation rate can be measured according to the ASTM 882 standard test by using an universal tensile strength tester. The reflective ratio can be determined by using a spectral colorimeter (SP-60) that measures the percentage of reflected light at 550 nm wavelength. During reflection measurement, the polyimide layer can be placed on a white substrate used as testing platform, and light can irradiated onto the polyimide layer. The light may pass through the polyimide film, and then reflect from the white substrate. Accordingly, the reflective ratio measured for a transparent polyimide layer (e.g., fabricated according to Example 1.4) can actually be the reflective ratio of the white substrate.

As shown in Table 1, when the incorporated amount of the white filler TiO₂ is increased (e.g., in Examples 1.1-1.3), the reflectivity and shielding ability of the polyimide can be improved (i.e., reduced light transmittance), but the elongation rate is significantly reduced (which may be adverse to certain product application). Even when the incorporated amount of the TiO₂ white filler is 40 wt % (e.g., Example 1.3), the resulting light transmittance ratio still cannot meet the current requirements for LED applications, which requires a total light transmittance ratio less than 15%.

For an identical amount of TiO₂ white filler (e.g., in Examples 1.2 and 1.5), increasing the film thickness can improve the overall shielding ability of the polyimide film. However, even when the thickness is doubled, a limited reduction of 9% of the light transmittance ratio is observed. This limited improvement cannot be sufficient for actual product applications.

Experiment 2

The polymer films fabricated according to Examples 2.1-2.5 and Comparative Examples 1-2 can be tested to determine a reflective ratio, light transmittance ratio, and chromaticity characteristics. The light transmittance ratio can be measured by using a testing apparatus available from Nippon Denshoku under the designation “PG-1M”. The chromaticity characteristics can be measured with a spectral colorimeter (SP-60) at room temperature. The chromaticity characteristics are expressed in the L*a*b* color space, wherein the L*-value characterizes the color luminance, the a*-value characterizes a color dimension from green to red, and the b*-value characterizes a color dimension from blue to yellow. Examples of the test results are shown in Table 2 below.

TABLE 2
Test results for the polymer film

| | TiO₂ | | | | | | |
|---|---|---|---|---|---|---|---|
| | content in | Total | Re- | light | | | |
| | adhesive | thick- | flective | trans- | | | |
| | layer | ness | ratio | mittance | | | |
| | (wt %) | (μm) | (%) | ratio (%) | L* | a* | b* |
| Example 2.1 | 10 | 50.4 | 84.2 | 20.3 | 93.9 | −3.0 | 3.8 |
| Example 2.2 | 20 | 51.2 | 85.4 | 16.7 | 94.2 | −3.0 | 3.7 |
| Example 2.3 | 30 | 50.4 | 86.3 | 11.2 | 94.9 | −3.1 | 3.6 |
| Example 2.4 | 50 | 51.3 | 87.2 | 8.8 | 95.0 | −3.2 | 3.5 |
| Example 2.5 | 70 | 49.2 | 88.5 | 5.3 | 95.3 | −3.3 | 3.4 |
| Comparative | 0 | 49.6 | 83.4 | 32.3 | 93.2 | −2.9 | 3.9 |
| Example 1 | | | | | | | |
| Comparative | 0 | 50.2 | 81.3 | 23.3 | 92.3 | −2.7 | 3.8 |
| Example 2 | | | | | | | |
| Example 1.2 | — | 12.0 | 83.0 | 33.1 | 93.4 | −2.9 | 3.9 |

As shown in Comparative Examples 1 and 2, when no TiO₂ white filler is incorporated in the adhesive layer, the polymer film exhibits insufficient shielding, and the light transmittance ratio is about 32%. Even if the polymer layer were made with a greater thickness (e.g., multiplied by two), the light transmittance ratio may still be above 20%. Accordingly, the requirement of a light transmittance ratio less than 15% for LED applications cannot be met when the white polyimide layer with increased thickness is merely used as the polymer film.

In contrast, the white polymer films fabricated according to in Examples 2.1-2.5 (i.e., with the addition of the TiO₂ white filler in the adhesive layer) can exhibit improved shielding and increased reflection, while maintaining stable chromaticity characteristics (e.g., stable and uniform white color).

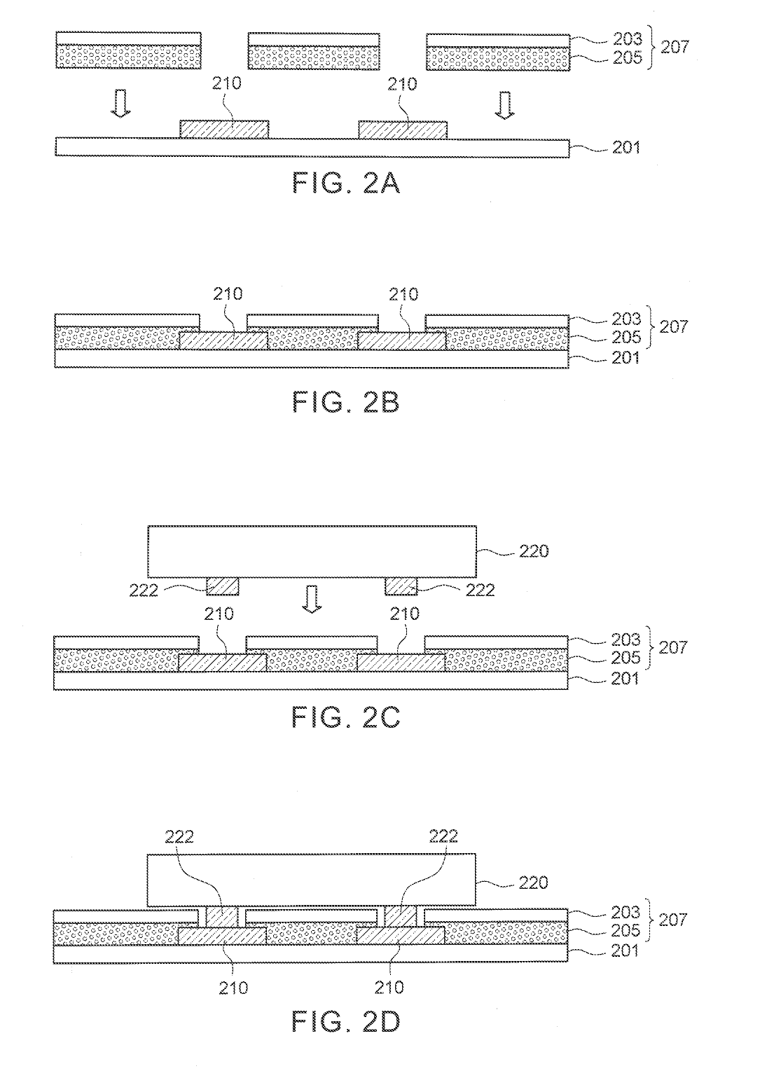

FIGS. 2A-2D are schematic views illustrating examples of process steps in the fabrication of a lighting assembly using the advantageous polymer films described previously. In FIG. 2A, a substrate 201, and a polymer film 207 including a white polyimide layer 203 and a white adhesive layer 205 are provided. In one embodiment, a metal layer 210 can be formed on an upper surface of the substrate 201. The substrate 201 can be made of polyimide, and the metal layer 210 can be made of copper. The polymer film 207 can be fabricated by coating the white adhesive layer 205 on a surface of the white polyimide layer 203.

Next referring to FIG. 2B, the substrate 201 and the polymer film 207 can be pressed against each other for adhesion for about 120 seconds at a temperature between about 160° C. and about 200° C., and then treated through a post-curing step for about 1 hour at a temperature of about 160° C. The polymer film 207 can partially cover the substrate 201, and at least partially expose the metal layer 210.

Referring to FIG. 2C, a lighting component 220 can be placed above the substrate 201 such that an electrode 222 of the lighting component 220 is aligned with the metal layer 210 on the substrate 201. In one embodiment, the lighting component 220 can be a light-emitting diode.

Referring to FIG. 2D, the lighting component 220 then can be mounted on the substrate 201 with the electrode 222 and the metal layer 210 bonded with each other. In this assembly, the polymer film 207 can be located at one side of the lighting component 220 so as to form a reflective surface on the substrate 201 for increasing light extraction. It is to be appreciated that the polymer film 207 can be generally used in any lighting applications, and is not particularly limited to light-emitting diode applications.

The polymer films described herein may have the ability to prevent yellowing or alterations that occur in conventional white films having a dual-layer structure when subject to high temperature. Additionally, the polymer films described herein can provide better flexibility and shielding.

In addition, the polymer films described herein can meet the requirements of high shielding and high reflection for lighting applications, can maintain stable chemical and physical properties, and can be fabricated with a cost-effective manufacturing process.

Realizations of the polymer films, related fabrication methods and applications have been described in the context of particular embodiments. These embodiments are meant to be illustrative and not limiting. Many variations, modifications, additions, and improvements are possible. These and other variations, modifications, additions, and improvements may fall within the scope of the invention as defined in the claims that follow.

What is claimed is:

1. A polymer film comprising:
a white polyimide layer; and
a white adhesive layer disposed on a surface of the white polyimide layer, the white adhesive layer including an adhesive agent and a first white filler distributed in the adhesive agent;
wherein the polymer film has a reflective ratio equal to or greater than about 80%.

2. The polymer film according to claim 1, wherein the adhesive agent is selected to from a group consisting of epoxy resins, acrylics, silicones, phenolics, polyurethanes, and rubbers.

3. The polymer film according to claim 1, wherein the first white filler is selected from a group consisting of TiO₂, ZrO₂, CaO, ZnO₂, Al₂O₃, ZnS₂, CaCO₃, PbCO₃, Pb(OH)₂, CaSO₄, BaSO₄, SiO₂, BN, AlN, basic zinc molybdate, basic calcium zinc molybdate, lead white, molybdenum white, lithopone, and clay.

4. The polymer film according to claim 1, wherein the amount of the first white filler is between about 5 wt % and about 80 wt % of a total weight of the white adhesive layer.

5. The polymer film according to claim 1, wherein the first white filler is a powder having an average particle diameter between about 0.1 μm and about 5 μm.

6. The polymer film according to claim 1, wherein the white adhesive layer has a thickness equal to or smaller than about 50 μm.

7. The polymer film according to claim 1, wherein the white polyimide layer includes a low chroma polyimide and a second white filler distributed in the low chroma polyimide.

8. The polymer film according to claim 7, wherein the low chroma polyimide has a b* value of less than about 10.

9. The polymer film according to claim 7, wherein the second white filler is selected from a group consisting of TiO₂, ZrO₂, CaO, ZnO₂, Al₂O₃, ZnS₂, CaCO₃, PbCO₃, Pb(OH)₂, CaSO₄, BaSO₄, SiO₂, BN, AlN, basic zinc molybdate, basic calcium zinc molybdate, lead white, molybdenum white, lithopone, and clay.

10. The polymer film according to claim 1, wherein the polyimide layer has a thickness less than about 30 μm.

11. The polymer film according to claim 1, having a transparency equal to or less than about 20%.

12. A lighting assembly comprising:
a substrate;
a lighting component disposed on the substrate; and
a reflective surface formed by a polymer film for reflecting light from the lighting component;
wherein the polymer film includes a white polyimide layer, and a white adhesive layer disposed on a surface of the white polyimide layer, wherein the white adhesive layer may comprise an adhesive agent and a white filler distributed in the adhesive agent, the polymer film having a reflective ratio equal to or greater than about 80%.

13. The lighting assembly according to claim 12, wherein the polymer film has a transparency equal to or smaller than about 20%.

14. The lighting assembly according to claim 12, wherein the adhesive agent is selected from a group consisting of epoxy resins, acrylics, silicones, phenolics, polyurethanes, and rubbers.

15. The lighting assembly according to claim 12, wherein the white filler is selected from a group consisting of TiO₂, ZrO₂, CaO, ZnO₂, Al₂O₃, ZnS₂, CaCO₃, PbCO₃, Pb(OH)₂, CaSO₄, BaSO₄, SiO₂, BN, AlN, basic zinc molybdate, basic calcium zinc molybdate, lead white, molybdenum white, lithopone, and clay.

16. The lighting assembly according to claim 12, wherein the amount of the white filler is between about 5 wt % and about 80 wt % of a total weight of the white adhesive layer.

17. The lighting assembly according to claim 12, wherein the white filler is a powder having an average particle diameter between about 0.1 μm and about 5 μm.

18. The lighting assembly according to claim 12, wherein the white adhesive layer has a thickness equal to or smaller than about 50 μm.

19. The lighting assembly according to claim 12, wherein the white polyimide layer includes a low chroma polyimide and a second white filler distributed in the low chroma polyimide.

20. The lighting assembly according to claim 18, wherein the low chroma polyimide has a b* value less than about 10.

21. The lighting assembly according to claim 19, wherein the second white filler is selected from a group consisting of TiO₂, ZrO₂, CaO, ZnO₂, Al₂O₃, ZnS₂, CaCO₃, PbCO₃, Pb(OH)₂, CaSO₄, BaSO₄, SiO₂, BN, AlN, basic zinc molybdate, basic calcium zinc molybdate, lead white, molybdenum white, lithopone, and clay.

22. The lighting assembly according to claim 12, wherein the white polyimide layer has a thickness less than about 30 μm.

23. The lighting assembly according to claim 12, wherein the lighting component is a light-emitting diode, and the polymer film is disposed on the substrate.
